(19) United States
(12) Patent Application Publication
(10) Pub. No.: US 2002/0164819 A1
(43) Pub. Date: Nov. 7, 2002

(54) Sample preparing arrangement and a method relating to such an arrangement

(76) Inventors: David Storek, Goteborg (SE); Niklaus Schneeberger, Boudry (CH); Britta Ottosson, Molndal (SE); Anatol Krozer, Goteborg (SE); Robert Otillar, San Francisco, CA (US)

Correspondence Address: RICHARD ARON OSMAN, SCIENCE AND TECHNOLOGY LAW GROUP, 75 DENISE DRIVE, HILLSBOROUGH, CA, 94010

(21) Appl. No.: 09/938,471

(22) Filed: Aug. 23, 2001

Related U.S. Application Data
(60) Provisional application No. 60/288,015, filed on May 2, 2001.

(51) Int. Cl. G01N 1/00

(52) U.S. Cl. 436/174; 436/518; 436/149; 436/150; 436/157; 436/806; 435/4; 435/6; 435/29; 435/287.2; 435/288.4; 422/82.01; 422/99; 422/102

(57) ABSTRACT

The present invention relates to an arrangement (10, 20) for preparing samples (15, 27), submergible in a liquid medium. The arrangement comprises a section provided with a device (13, 23) for controllable generation of a magnetic field through influence of a control signal, said magnetic field being generated to trap at least part of said samples (15, 27).

### CROSS-REFERENCE TO RELATED APPLICATION This application claims priority to U.S. Application Ser. No. 60/288,015, filed Aug. 24, 2000.

### TECHNICAL FIELD OF THE INVENTION

The present invention relates to a chip-based method and arrangement for preparing, manipulating or detecting samples.

### BACKGROUND OF THE INVENTION

There exists an enormous number of processes occurring in an organism per unit time and also in each cell of the organism. One needs therefore fast techniques enabling acquisition of information in parallel, and effective means of storage and handling of such information.

High throughput screening (HTS) examines in parallel as small samples as possible (so as not to use large amounts of expensive and rare chemicals) and as many of these as possible, usually arranged in a dense, ordered solid-phase matrix, often referred to as a “chip”.

One example of such preparation is given in FIG. 1 (Biophotonics, January/February 2000, Univ. of Wisconsin, Franco Cerrina, et.al.). According to this technique, a matrix is created by burning away deposits from certain selected places on a chip, while depositing additional chemicals on other places. This method, although fairly fast and cheap, produces a permanent pattern on a matrix, which will be used up after single experiment. Thus, each new experiment requires production of a new matrix.

The number of elements (spots) in a matrix varies depending on the preparation method, but usually does not exceed 10,000, although matrices as large as 1,000,000 sites have been reported. The outcome of each single “experiment” therefore gives at best 10,000 results. In reality this number is much lower (around 20%) due to the very poor quality of even the best matrices produced to date.

Apart from preparation mentioned above a complete HTS-system has to include also means of detection for the events taking place in each spot as well as data transfer and evaluation.

Relevant literature includes: FR 2,781,886; U.S. Pat. No. 5,874,219; U.S. Pat. No. 5,922,617; U.S. Pat. No. 5,755,942; WO 00/43534; WO 00/49382; WO 00/60356; and WO 00/54882.

### SUMMARY OF THE INVENTION

One object of the invention is to present an arrangement which improves the “one by one” experimentation.

The technique allows a relatively rapid screening of new chemicals to be used as drugs, both with regard to their function and (importantly) with regard to the determination of the side effects that a given drug might exert, but can also be used in many other applications such as genome determination, proteomics and others.

In this invention, a different route as compared to above-mentioned prior art is followed. The idea is not to prepare a ready-to-use-product, which is impossible to modify, but to allow a user for possibility to prepare its own “experiment”. Thus, one object of the invention is to provide an easy-to-handle platform, which could be used repeatedly and could be prepared in-house. Consequently, the invention is not limited to the surface deposits as are the devices described above (see also FIG. 1), but allows sample preparation either by surface deposition (at the bottom or at the walls of a crater) or by utilizing liquid state reactions allowing reagent contained in the liquid trapped within each well by a cap to mix with reagents contained in the liquid above the craters by opening the “lids” (caps) at will.

In the arrangement according to the invention, it is relatively easy to change both the dimensions and the number of the wells. Also the simplicity of the design will allow integrating the reaction product detection system on-chip and perhaps also the facility for multi-well deposition of the active substance.

Another object of the invention is to describe how the detection limits for the events under study can be improved using techniques similar to those used for chip production.

These objects are achieved by the initially mentioned arrangement, which comprises a section provided with a device for controllable generation of a magnetic field through influence of a control signal, said magnetic field being generated to trap at least part of said samples. Preferably, said device is a coil or a magnetically active material and it is made of an electrically conducting material, preferably aluminium. Each device is applied through a conductor of a current of different strength, whereby the current amplitude and the number of windings in the coil are proportional to the strength of the magnetic field.

According to the first aspect of the invention the arrangement comprises a cavity provided in a substrate and a lid for closing said cavity. Preferably, the lid is a magnetic bead. The bead is directed onto a cavity using external magnets that create magnetic fields counteracting the field created by the material deposited around each cavity. Each cavity is surrounded by a device, which directs said lid using external magnets that create magnetic fields counteracting the field created by material deposited around each cavity. The cavities are etched in a silicon surface and the lid is provided as a large magnetic particle in the liquid. The particle is attracted to a predetermined cavity when the coil of said cavity is energised by electric current to produce magnetic field of spatial attraction. Before sealing off the cavity, smaller magnetic particles are attracted into the cavity. The sample is a magnetic particle covered with appropriate chemical(s). In one embodiment, the arrangement comprises means for detection of presence of a magnetic capping lid capping a cavity. In one embodiment, the capping is detected by detecting the change in inductance in the control circuit, which produces the attractive magnetic field, whereby the bead acts like a magnetic yoke in a transformer, increasing the inductance. In another embodiment, the capping is detected through decrease of electromagnetic radiation to a detector inside the cavity or by changes of capacitance between electrodes inside the cavity or near a cavity rim.

The arrangement may also comprise means for detection of changes of inductance when a magnetic particle passes through the opening into or out of a cavity. The indication is determined using the direction of an externally controlled magnetic field, either by changing the direction of the electric current flowing through a coil or flipping an external magnet. Preferably, the particle contains particular molecular coating, which reacts with the liquid in that cavity or with the coating adsorbed on the walls of the cavity.

The substrate can be made of silicon, Si, or of Si-compound, such as Si-oxide Si-nitride or Si-carbide, or combinations thereof, or a suitable polymer, such as polyethylene, polyethylene glycol, polyethylene oxide, fluorine containing a polymer (PTFE -Teflon), or silicon containing a polymer.

According to a second aspect of the invention, the arrangement comprises a member for generating acoustic waves and said device on a substrate or carrier. The device and the member for generating acoustic waves are covered with an insulating layer. On the insulating layer, a combination of receptor-bead of a magnetisable material are attached. A sample is provided with a magnetic portion, which can be attracted towards the receptor. The combination of receptor-bead attenuate the acoustic wave stronger than receptors attached to the insulating layer. Preferably, the surface of the insulating layer is inert to receptors, and the receptor-bead combination is attached to the surface by magnetic forces acting on the bead.

The invention also relates to a method of preparing samples, by means of an arrangement submergible in a liquid medium, said arrangement comprising a section provided with a device for generation of a magnetic field. The method comprises the steps of connecting a signal to said device and generating a magnetic field to trap at least part of said samples. To each device is applied a current of different strength. The arrangement is provided by a cavity in a substrate. The method comprises the further steps of arranging a magnetic lid for closing said cavity, directing said bead onto a cavity using external magnets that create magnetic fields counteracting the field created by the material deposited around each cavity, and attracting smaller magnetic particles into the cavity before sealing off the cavity. Preferably, the sample is a magnetic particle covered with an appropriate chemical(s). According to the method it is possible to detect presence of a magnetic capping lid capping a cavity. The capping is determined by detecting the change in inductance in the control circuit, which produces the attractive magnetic field, whereby the bead acts like a magnetic yoke in a transformer, increasing the inductance. The capping may also be determined through decrease of electromagnetic radiation to a detector inside the cavity or by changes of capacitance between electrodes inside the cavity or near the cavity rim. According to the method it is possible to detect changes of inductance when a magnetic particle passes through the opening into or out of a cavity, and determining said indication using the direction of an externally controlled magnetic field, either by changing the direction of the electric current flowing through a coil or flipping an external magnet.

According to the method, given a known number of samples in each cavity and a density of respective coatings, quantitative data on the number of reaction between the coating on a wall of the cavity and the coating on a small sample is obtained by counting the number of samples.

In particular aspects, the invention provides embodiments:

1. An arrangement (10, 20) for preparing samples (15, 27), submergible in a liquid medium, characterised in, that the arrangement comprises a section provided with a device (13, 23) for controllable generation of a magnetic field through influence of a control signal, said magnetic field being generated to trap at least part of said samples (15, 27).

2. The arrangement according to embodiment 1, characterised in, that said device (13, 23) comprises a coil.

3. The arrangement according to embodiment 1, characterised in, that said device comprises a magnetically active material.

4. The arrangement according to any of preceding embodiments, characterised in, that the device comprises an electrically conducting material, preferably aluminium.

5. The arrangement according to any of preceding embodiments, characterised in, that each device through a conductor (17) is applied a current of different strength.

6. The arrangement according to embodiment 2, characterised in, that a current amplitude and the number of windings in the coil are proportional to the strength of the magnetic field.

7. The arrangement (10) according to any one of embodiments 1-6, characterised in that said arrangement comprises a cavity (12) provided in a substrate (11).

8. The arrangement according to embodiment 7, characterised in, that it comprises a lid (14) for closing said cavity (12).

9. The arrangement according to embodiment 8, characterised in, that said lid (14) is a magnetic bead.

10. The arrangement according to embodiment 3 and 9, characterised in, that the bead is directed onto a cavity using external magnets that create magnetic fields counteracting the field created by the material deposited around each cavity (12).

11. The arrangement according to embodiment 9, characterised in, that said lid is a micro-bead introduced in said liquid medium.

12. The arrangement according to embodiment 7, characterised in, that each cavity is surrounded by a device, which directs said lid using external magnets that create magnetic fields counteracting the field created by material deposited around each cavity (12).

13. The arrangement according to embodiment 7, characterised in, that the cavities are etched in a silicon surface and the lid is provided as a large magnetic particle (14) in the liquid.

14. The arrangement according to embodiment 13, characterised in, that said particle (14) is attracted to a predetermined cavity when the coil of said cavity is energised by electric current to produce magnetic field of spatial attraction.

15. The arrangement according to embodiment 14, characterised in, that before sealing off the cavity, smaller magnetic particles are attracted into the cavity.

16. The arrangement according to any of preceding embodiments, characterised in, that said sample (15) is a magnetic particle covered with appropriate chemical(s).

17. The arrangement according to any of preceding embodiments, characterised in, that the arrangement comprises means for detection of presence of a magnetic capping lid capping a cavity.

18. The arrangement according to embodiment 17, characterised in, that said capping is detected by detecting the change in inductance in the control circuit, which produces the attractive magnetic field, whereby the bead acts like a magnetic yoke in a transformer, increasing the inductance.

19. The arrangement according to embodiment 17, characterised in, that said capping is detected through decrease of electromagnetic radiation to a detector inside the cavity or by changes of capacitance between electrodes inside the cavity or near a cavity rim.

20. The arrangement according to any of preceding embodiments, characterised in, that it comprises means for detection of changes of inductance when a magnetic particle passes through the opening into or out of a cavity.

21. The arrangement according to embodiment 20, characterised in, that the indication is determined using the direction of externally controlled magnetic field, either by changing the direction of the electric current flowing through a coil or flipping an external magnetic.

22. The arrangement according to embodiment 20 or 21, characterised in, that said particle contains particular molecular coating, which reacts with the liquid in that cavity or with the coating adsorbed on the walls of the cavity.

23. The arrangement according to any of embodiments 7-16, characterised in, that the substrate is made of silicon, Si, or of Si-compound, such as Si-oxide Si-nitride or Si-carbide, or combinations thereof, or a suitable polymer, such as polyethylene, polyethylene glycol, polyethylene oxide, fluorine containing a polymer (PTFE -Teflon), or silicon containing a polymer.

24. The arrangement according to any of embodiments 1-6, characterised in, that the arrangement (20) comprises a member (22) for generating acoustic waves and said device (23) on a substrate or carrier (21).

25. The arrangement according to embodiment 24, characterised in, that the device and the member for generating acoustic waves are covered with an insulating layer (24).

26. The arrangement according to embodiment 24, characterised in, that on the insulating layer, a combination of receptor-bead (25) of a magnetisable material is attached.

27. The arrangement according to embodiment 26, characterised in, that a sample (27) is provided with a magnetic portion (28), which can be attracted towards the receptor (25, 26).

28. The arrangement according to embodiment 26, characterised in, that said combination of receptor-bead attenuate the acoustic wave (29) stronger than do receptors attached to the insulating layer (24).

29. The arrangement according to any of embodiments 25-28, characterised in that said surface of the insulating layer (24) is inert to receptors, and that the receptor-bead combination is attached to the surface by magnetic forces acting on the bead.

30. A method of preparing samples (15, 27), by means of an arrangement (10, 20) submergible in a liquid medium, said arrangement comprising a section provided with a device (13, 23) for generation of a magnetic field, characterised by connecting a signal to said device (13, 23) and generating a magnetic field to trap at least part of said samples (15, 27).

31. The method of embodiment 30, characterised in that to each device is applied a current of different strength.

32. The method of embodiment 30, characterised in that said arrangement is provided by a cavity (12) in a substrate (11).

33. The method of embodiment 32, characterised by arranging a magnetic lid (14) for closing said cavity (12).

34. The method of embodiment 33, characterised by directing said bead onto a cavity using external magnets that create magnetic fields counteracting the field created by the material deposited around each cavity (12).

35. The method according to any of embodiments 30-34, characterised by attracting smaller magnetic particles into the cavity before sealing off the cavity.

36. The method according to any of embodiments 30-34, characterised in that said sample is a magnetic particle covered with an appropriate chemical(s).

37. The method according to any of embodiments 30-35, characterised by detection of presence of a magnetic capping lid capping a cavity.

38. The method according to embodiment 37, characterised by detecting said capping by detecting the change in inductance in the control circuit, which produces the attractive magnetic field, whereby the bead acts like a magnetic yoke in a transformer, increasing the inductance.

39. The method according to embodiments 37, characterised by detecting said capping through decrease of electromagnetic radiation to a detector inside the cavity or by changes of capacitance between electrodes inside the cavity or near the cavity rim.

40. The method according to any of preceding embodiments, characterised by detection of changes of inductance when a magnetic particle passes through the opening into or out of a cavity.

41. The method according to embodiment 40, characterised by determining said indication using the direction of externally controlled magnetic field, either by changing the direction of the electric current flowing through a coil or flipping an external magnetic.

42. The method according to any of embodiments 30-41, characterised by given a known number of samples in each cavity and a density of respective coatings, quantitative data on the number of reaction between the coating on a wall of the cavity and the coating on a small sample is obtained by counting the number of samples.

### BRIEF DESCRIPTION OF THE DRAWINGS

In the following, the invention will be further described in a non-limiting way under reference to the accompanying drawings in which:

FIG. 1 shows an arrangement according to prior art,

FIG. 2 is a schematic view from above of chip according to the invention,

FIG. 3 is a schematic view, showing an enlarged cross-section along line 11-1 through a part of the chip according to FIG. 2,

FIG. 4 is a schematic view from above of a part of another chip according to the invention, and

FIG. 5 is a schematic view, showing an enlarged cross-section along line IV-IV through a part of the chip according to FIG. 4.

FIG. 6 is a schematic view, showing an enlarged cross-section of a portion of FIG. 5 under (A) no magnetic field, (B) an attractive field, and (C) a repulsive field.

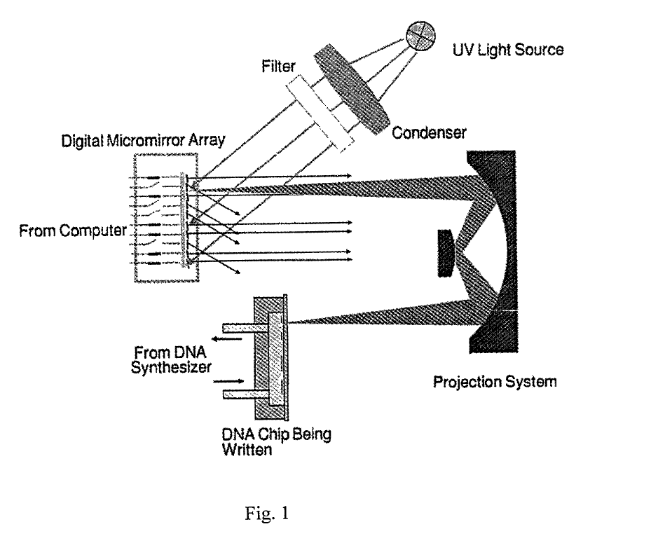

### DETAILED DESCRIPTION OF THE PARTICULAR EMBODIMENTS

The basic idea of the present invention is to create an enclosure or a crater (a well), provided with a lid, which can be opened and closed by a “lid”. A user can control the lid and the device is intended to be submerged in a liquid medium. By operating the lid, the enclosed volume becomes separated from the surroundings. That means, the liquid stored in the crater, particles suspended therein, and/or material that adheres to the craters inner surface are not affected by subsequent changes that occur in the surroundings while the lid is closed. These changes might be a different chemical composition of the liquid, light shining on the crater chip, or other solids in the surrounding liquid. The lid may or may not be completely liquid-tight, but mixing of the liquid outside a crater with the liquid contained inside a well will be dramatically slowed. Hence, solids and liquids will be well separated between inside and outside, by the lid.

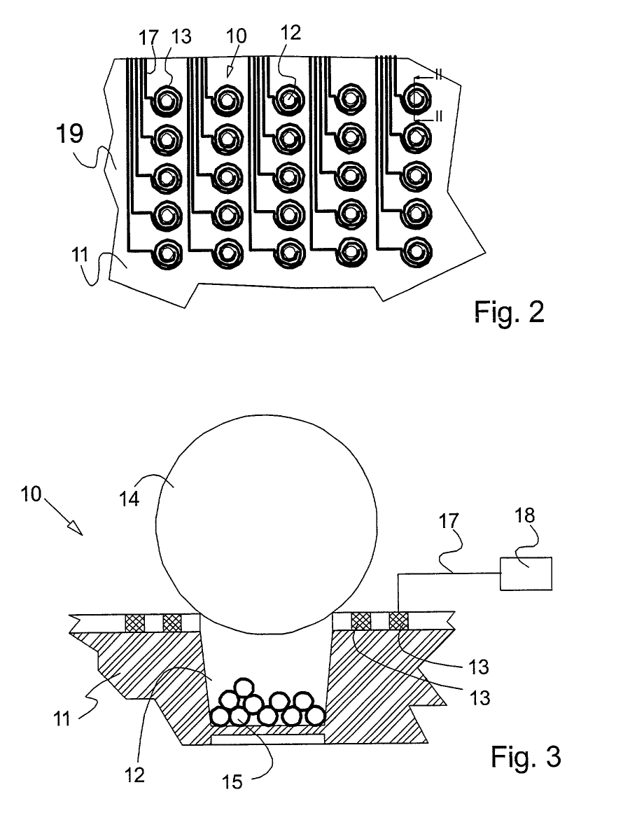

FIGS. 2 and 3 illustrate a first example of an arrangement according to the invention. FIG. 2 illustratess an enlarged schematic view of a part of chip 19 comprising a number of sample collecting arrangements 10. Each sample collecting arrangement comprises a cavity (crater, pocket, well) 12 provided in a substrate 11 and means 13 to control the cap (lid, cover) 14. Each control means 13 is connected to controller 18 (FIG. 3) through connections 17.

FIG. 3 is a schematic cross-section through the device 10. However, the device 10 is shown in a stage where samples 15 are collected and the crater 12 is closed by means of the lid or closure 14. The samples in this particular case are magnetic particles of diameter(s) much smaller than the diameter of the lid, covered with appropriate chemical(s)

In this embodiment, the lid control means 13 comprise electrically actuated coils and the lid 14 is a magnetizeable bead.

By making many craters 12, all with individually controlled lids 14, different types of mixing of solids dispensed in a liquid and/or liquids can be achieved at the same time. As different liquids/solids are introduced to the outside of the craters only user-selected craters with open lids will be reached for the mixing by the liquids/solids external to the closed craters.

The dimensions and the shapes of each crater 12 can of course vary within a large interval both with respect to its diameter and depth. The craters can have circular cross-section, e.g. having about 50 μm deep with the diameters of approximately 100 μm. It is relatively easy to produce craters with dimensions ranging from few Jim and larger and with depth ranging from few μm and up to several hundreds of μm, having, e.g. square shapes.

The material of the substrate can be silicon and the manufacturing process may include micro-machining, similar to the process of making microprocessors or memories chips. A device may contain from several hundreds of craters on a single piece of silicon, providing a so-called chip. Of course tens of thousands of craters on commercial units can be arranged.

Preferably, the lid is a micro-bead introduced in a liquid. The lid-actuation mechanism, i.e. the closing and the opening of each of the craters is performed using switchable magnetic fields that influence the motion of the introduced beads. The magnetic fields are created using the coils 13 deposited around each crater.

The coils 13 surrounding each of the craters are made of an electrically conducting material. In the preferred embodiment the conductor is made of aluminium, A1, but any electrical conductor can be used. Preferably, each coil is accessible through electrically conducting leads so that a current of different strength can be applied separately to each coil. The current amplitude and the number of windings in the coil are proportional to the strength of the magnetic field, which can thus be varied. Clearly, it is possible to change the number of windings in the coils surrounding each crater as well as their width and thickness within a broad range of dimensions. Preferably but not exclusively, coils can have from 2 and up to 10 windings.

In an alternative embodiment, instead of the coils 13, the control means can be substituted by a magnetically active material surrounding each crater and direct the beads using external magnets that will create magnetic fields counteracting the field created by the material deposited around each crater 12.

Preferably, the craters are etched in the silicon surface and the lid is provided by a large magnetic particle 14 in the liquid. Thus, particle 14 can be attracted to the crater of choice when the coil of this crater is energised by electric current to produce magnetic field for spatial attraction. Before sealing off the crater of choice, however, it is also possible to attract smaller magnetic particles into the crater. To attract the smaller magnetic particles 15 to the crater we energize the coil by leading electric current through it. When the coil is energized, a magnetic field is established. This field will attract the magnetic particle 15 from the liquid. These smaller particles have higher mobility in the liquid compared to the mobility of larger particles and will thus reach crater faster than the larger lids. The large lid-particle will cap the crater at a later stage. Preferably, as large particles commercially available magnetic particles such as ferromagnetic or super-paramagnetic having about 100 micrometers in size can be used, while the size of the smaller particles is much smaller than the crater's size. There are other dimensions and particle types on the market and the invention is applicable to a broad range of particle sizes, shapes and materials.

To open a closed crater, a repelling field is generated either externally or by inverting the direction of the current flowing through the coil. It is also possible to terminate the current through the coil, whereby the particle may be released due to shear force from the flowing liquid or due to gravitational forces if the craters are positioned “upside down”.

The simple actuation of the crater lid using current controlled magnetic field(s) and the large number of craters on a chip makes it necessary that the chip is operated automatically through controlling arrangement. The chip is preferably provided with an interface device that establishes electrical connection with the chip and provides the handling of the surrounding fluid with the beads and chemicals. After use the chip may be removed for cleaning and reuse or disposal. The interface device will be connected to a computer equipped with suitable software to control the sequence of operations on the craters and the liquid handling system. The software will also provide an interface for the user to establish the process sequence and to plan the states of the crater lids in each sequence.

Detection of a magnetic capping bead can also be done. It is important to obtain feedback on which craters are capped. The presence of a magnetic capping bead, in place over a crater, can be detected by the change in inductance in the electric circuit, which produces the attractive magnetic field. The bead acts like a magnetic yoke in a transformer, increasing the inductance. A resonant, or other, circuit can then detect this inductance change.

The presence of the capping bead can be detected by various other schemes, like the decrease of electromagnetic radiation to a detector inside the crater or by changes of capacitance between electrodes inside the crater or near the crater rim.

Another possible application along similar lines is the detection of changes of inductance when a small magnetic sphere passes through the opening into a well. Using the arrangement according to the invention it is possible to determine whether a sphere is entering the well or if it is leaving the well. This is determined using the direction of externally controlled magnetic field (either by changing the direction of the electric current flowing through a coil or flipping an external magnetic field creating device by other means). Such a sphere may contain particular molecular coating, which will react with the liquid in that well or with the coating adsorbed on the walls of the crater. Given one knows the number of spheres in each well and the density of the respective coatings quantitative data on the number of reaction between the coating on the wall and the coating on a small bead can be obtained by simply counting the spheres.

Following non-limiting examples are given for simplifying the understanding of the invention: According to a first example liquid A containing magnetic beads is introduced. User selected craters 12 are energized and hence capped. The remaining beads are flushed away with a cleaning liquid. Now liquid B is introduced, containing small (much smaller than the capping beads) particles, called X, made of a material interesting to the user. Only uncapped craters will accept X. Then, more magnetic beads are introduced and selected craters are capped, trapping X. Cleaning liquid will flush all excess away. A liquid containing chemical reagent Y can then be introduced and some craters are opened. X and Y are allowed to mix and react, but only in the user-selected areas. This reaction can be followed using sensing techniques, which can easily be incorporated into the system, for example using optical techniques. Other possible novel detection techniques easily incorporated into the present embodiment are mentioned below.

In a second example, a substance is attached to the craters inner surface. In a repeating sequence some craters are closed by the beads and the others are exposed to a reactive chemical A. After the reaction the chemical is flushed and some craters are exposed to another chemical B. So there will be craters that have been exposed to A and B, some to A, some to B, and some to neither. This process can be repeated with many chemicals producing very large numbers of differently modified substances residing in different locations (craters) of choice. With a sequence of 10 different chemicals, for example, more than 1000 different combinations are obtained. In particular, this could be used to synthesize DNA strands or (using appropriate well-known techniques) to investigate the function(s) of different proteins.

Yet another application is to lock cells in the wells filled with different chemicals and monitor the reaction of cells (cell proliferation, differentiation, spreading or others) to these chemistries. This would enable, for example a fast high throughput screening of drugs.

The arrangement may also be used separately, one-by-one, for example to deliver a certain chemical or chemicals locally at a certain place or places in a reaction vessel, and monitor reaction products locally, or to deliver a drug inside a body.

Another field of possible applications of the device has been triggered by something generally referred to as a “low throughput screening” (LTS). LTS is often used when the amount of required information is smaller but in addition one wants to obtain some quantitative information about concentrations of analyses or number of reactions that occur during certain time at certain amounts of reagents. The idea behind LTS has much in common with another timely idea often used to day: an “electronic tongue”. Electronic tongue is a device that enables one to determine components in a liquid. These components can then be associated with certain tastes (sweet, sour, salt, etc. or combinations thereof). To determine the content of simple liquids in a liquid mixture, for example % of sugar dissolved in a cup of tea along with the amount of tea used to prepare this cup, and even perhaps different tea blends used. To acquire knowledge about all these requires performing several experiments with constituents that react differently to different tea blends and to different amounts of tea from each blend that has been used, as well as to the amounts of sugar being dissolved in this tea. All these can be made by LTS methods using our equipment and choosing appropriate reagents different for each crater and letting these first to react with a “standard” samples (“learning the tongue” to recognise certain non-mixed liquids) and later exposing these samples to mixtures of different tea blends with or without sugar. Appropriate data processing from the outcome compared with the results obtained on standard samples enables one often to obtain information about tea blends used and the amount of sugar dissolved.

The device is not limited to spheres or coils for creation of magnetic fields that direct beads nor is it limited to the use of beads, and other shapes can be used. Finally it is not limited to the use of silicon technology to fabricate the crater matrices; other materials can be used for this purpose.

Following are additional, non-limiting, examples of different crater preparation techniques and materials of use paired with its utilisation:

The general idea behind these examples is to manipulate small particles in order to bring them to a chosen place on the surface of the substrate using magnetic field(s) as a driving force for particle manipulation. The surface of the substrate may be either patterned in a particular manner, or not. When the substrate is patterned and the pattern consists of craters some particles are used preferably as caps or lids to close each crater as described earlier. When the substrate is left without a pattern or patterned in a different manner (see below for an example) the particles can be used mainly as a way to enhance sensitivity of detection of the processes taking place in the device.

The magnetic force to manipulate the particles can be created using coils as described above, but it also may be created using externally applied magnets. In the former case the field strength (and thus the magnitude of the force) is determined primarily by the number of windings in the coil and the magnitude of the electric current. In the latter case it is possible to control the magnitude of the magnetic force by appropriate choice of magnet position and strength.

The substrate may be made of silicon (described above), Si, or of Si-compound, e.g. Si-oxide Si-nitride or Si-carbide, or combinations thereof. It may also consist of thin self-supporting Si, or of a Si-compound, with another film of suitable thickness (for example few micrometers), such as ZnO, evaporated onto its surface. This additional film is needed if the device is to work as an acoustic wave device for detection.

The substrate may also be fabricated using other material than silicon. For example a suitable polymer, e.g. polyethylene, polyethylene glycol, polyethylene oxide, fluorine containing a polymer (PTFE-Teflon), or silicon containing a polymer, may be used as a substrate material.

When patterning the substrate different techniques may be used depending on the substrate material and the pattern. Thus, Si and Si-compounds are suitably patterned applying well-known techniques from the semiconductor fabrication. When patterning polymers one can use known techniques like polymer stamping or moulding.

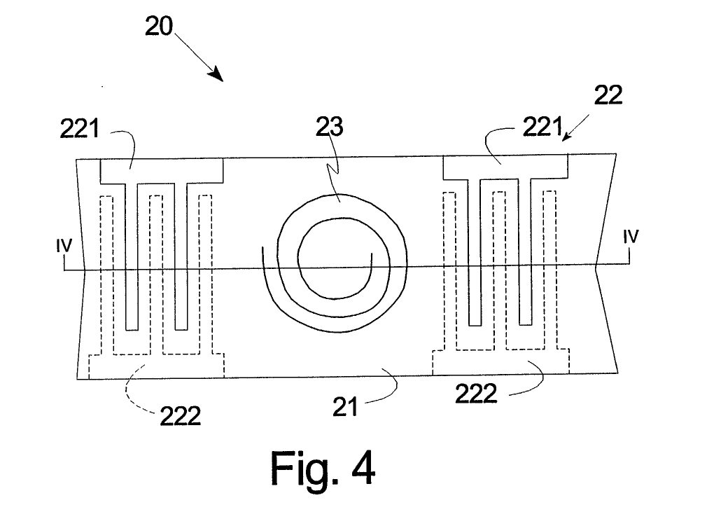

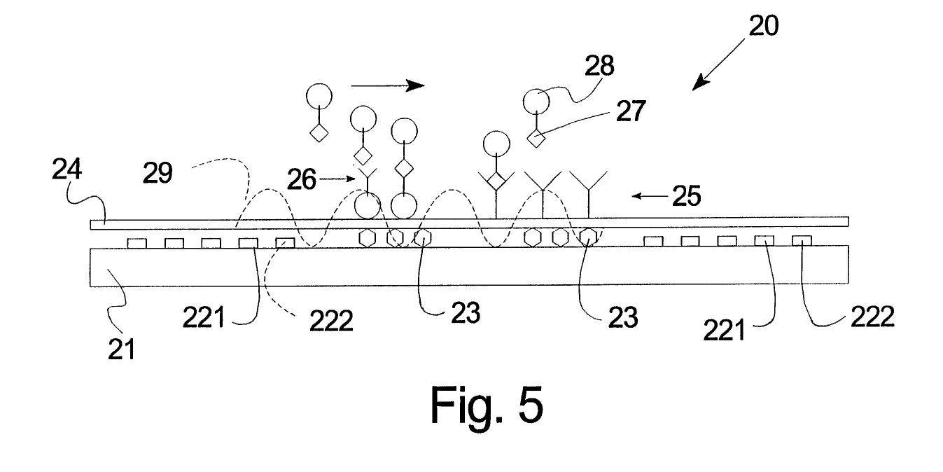

The patterns on the substrate are not limited to craters. For example when using the device as an acoustic wave detector one may produce matrices consisting of many interdigitated patterns needed for acoustic wave generation and detection. FIGS. 4 and 5 show one example of such a device.

The coils can be patterned using well-known techniques such as electroplating, vapour deposition or sputter.

In the following, few non-limiting examples of how similar techniques based on the magnetic manipulation of beads can be used to enhance detection sensitivity of chemical reactions are described:

A single site of a matrix of the Surface Acoustic Wave, SAW, devices is shown in FIGS. 4 and 5 Each device 20, comprises an arrangement 22 for generating acoustic waves and magnetic field control means 23 on a substrate or carrier 21. The arrangement for generation and detection of acoustic waves comprises two finger-shaped, reversed arranged conductors 221 and 222 provided on both sides of the control means 23. The control means 23 is arranged as a coil connected to a controller (not shown) as described in conjunction with foregoing embodiment. The coil and the arrangement for generating acoustic waves are covered with an insulating layer 24 (FIG. 5), made of, e.g. glass or plastic, or a biomolecular layer. Onto this insulating layer, (biomolecular) “receptors” 25 can be adsorbed. The receptors, 25, can be used in their native state and adsorb spontaneously onto a suitably prepared insulating layer, 24. They may also be pre-adsorbed onto small magnetic beads, 23, and the whole complex (magnetic bead-receptor) can be attracted to the surface of the SAW—device by magnetic field created by letting the current pass through the coil 23. The beads+receptors attenuate the acoustic wave, 29, many times stronger compared to the case when native receptors are attached to the insulating layer 24 and thus much lower concentrations of adsorbates at the surface are needed when the receptor-bead complexes are adsorbed.

Another advantage of such configuration is that it allows for the regeneration of the device. It may be possible to manufacture the surface of the insulating layer, 24, inert to receptors themselves, so that the receptor and bead complex is attached to the surface by magnetic forces acting on a bead. Once the investigation is completed the magnetic field can be removed (or the direction of the field changed using external magnet) causing the receptor and bead complex to desorb. This will leave the surface in its as-prepared state ready for another investigation.

If one wishes to study the reaction between these receptors and appropriate “donors”, 27, the latter may be introduced in their native stage (27), or coupled to a magnetic bead 28.

Again, coupling the donors to magnetic beads allows for larger attenuation of acoustic wave when the acceptor-donor reaction has occurred (irrespective from whether this reaction caused additional donor-derived beads to be adsorbed on the surface or whether it caused the desorption of the reaction product−receptor +bead/donor +bead) which decreases the necessary number of reaction needed for a given sensitivity of the device.

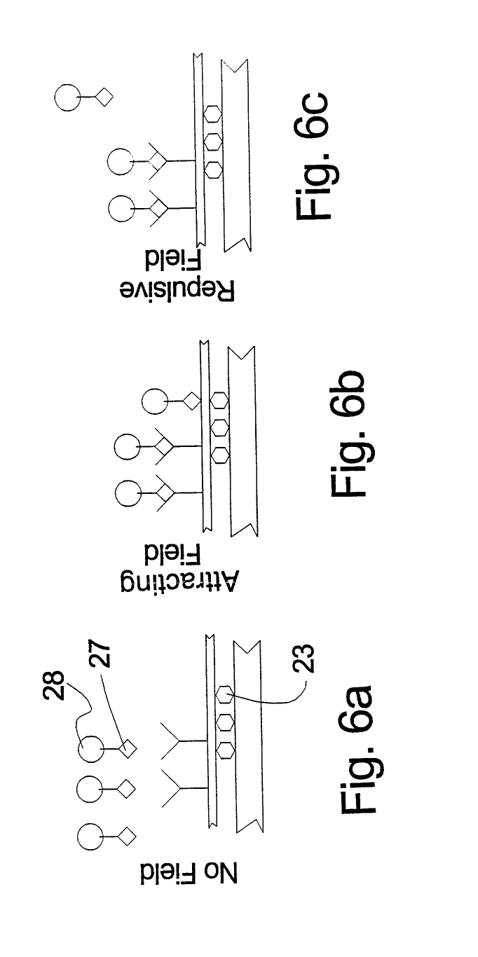

Since the beads influence the propagation of acoustic waves stronger than do the molecules, which react, to each other one obtains manifold enhancement of the detection of the chemical reaction involving these molecules. One particular, but far from the only one, example of such reaction is the antibody-antigene reaction. Another example would be DNA-complementary DNA (or PNA) reaction. The reaction may occur spontaneously over many sites of the matrix, leaving other sites unreacted. By separately applying the magnetic field so as to remove particles from each site one obtains (i) a pattern over sites where reaction did take place, and (ii) a quantitative information about the number of reaction that did take place at each site (see, FIG. 6A-6C).

Another way to use the matrix with interdigitated electrodes is as a capacitor; a certain number of electrode pairs will be considered as a single site and will constitute a capacitor. One prepares each site of the matrix differently, i.e. using different chemistries. By directing beads, with specific molecules attached to them, to these sites using magnetic field, or withdrawing particles from these sites, one is able to perturb the dielectric constant of a layer close to the surface and therefore produce large changes of the capacitance of the device compared to attachment of only (bio)molecules.

The invention is not limited the shown embodiments but can be varied in a number of ways without departing from the scope of the appended claims and the arrangement and the method can be implemented in various ways depending on application, functional units, needs and requirements etc.

What is claimed is:

1. A chip which uses magnetically controlled beads to regulate localization at discrete elements of the chip agents present in a fluid medium, the chip comprising:
a substrate comprising a plurality of elements, each comprising an integrated magnetic field generating device;
a plurality of beads; and
a controller controllably coupled to each device; wherein each device independently, controllably and reversibly generates alternative attractive and repulsive magnetic fields through influence of a control signal generated by the controller, said magnetic fields sufficient to independently, controllably and reversibly magnetically attract and repel one of the beads to and from the element, respectively, to regulate localization of a subset of the agents at the element.

2. A chip according to claim 1, wherein each element further comprises one or more detectors sensitive to the proximity to the element of the bead or the agents.

3. A chip according to claim 2, wherein the detector is a capacitance, inductance or optical detector.

4. A chip according to claim 1, wherein the beads are spherical.

5. A chip according to claim 1, wherein the agents are immobilized on the beads and the attraction of the beads to the elements promotes reaction of the subset agents with reagents immobilized at the element, and subsequent repulsion of the beads from the elements enhances detection of the reaction by a bead proximity dependent signal.

6. A chip according to claim 5, wherein each device reversibly magnetically attracts and repels a plurality of the beads to and from the element, respectively.

7. A chip according to claim 6, wherein the reaction comprises specific binding of the subset of the agents to the reagents.

8. A chip according to claim 1, wherein each element farther comprises a cavity, each bead is a cavity capping bead having a cross-sectional area larger than the opening of the cavity, and the attraction and repulsion of the capping bead is sufficient to move the capping bead between an unsealed, uncapped position, opening the cavity and a sealed, capped position, closing the cavity.

9. A chip according to claim 8, wherein the cavity contains one or more particles, each having a cross-sectional area smaller than the opening of the cavity.

10. A chip according to claim 9, wherein the particles are derivatized with a reagent which selectively reacts with or binds the subset of the agents.

11. A chip according to claim 9, wherein the particles are movable within the cavity by the magnetic fields generated by the corresponding device.

12. A chip according to claim 9, wherein the magnetic fields, in conjunction with movement of the capping bead, are sufficient to controllably move one or more of the particles into and/or out of the cavity.

13. A chip according to claim 8, wherein the device comprises a coil.

14. A chip according to claim 8, wherein the device comprises a magnetically active material.

15. A chip according to claim 8, wherein the device comprises an electrically conducting material.

16. A chip according to claim 8, wherein the cavities are etched in a silicon substrate surface.

17. A chip according to claim 8, wherein the element further comprises a member for generating acoustic waves.

18. A method of using a chip according to claim 1, the method comprising the steps of modulating the controller to effect the alternative attractive and repulsive magnetic fields to independently, controllably and reversibly magnetically attract and repel one of the beads to and from the element, respectively.

19. A method of using a chip according to claim 5, the method comprising the steps of modulating the controller to effect the alternative attractive and repulsive magnetic fields to independently, controllably and reversibly magnetically attract and repel one of the beads to and from the element, respectively.

20. A method of using a chip according to claim 8, the method comprising the steps of modulating the controller to effect the alternative attractive and repulsive magnetic fields to independently, controllably and reversibly magnetically attract and repel one of the beads to and from the element, respectively.
